(19) United States
(12) Patent Application Publication
(10) Pub. No.: US 2016/0339818 A1
(43) Pub. Date: Nov. 24, 2016

(54) AN IMPROVED SEAT

(71) Applicant: JANKEL ARMOURING LIMITED, Weybridge Surrey (GB)

(72) Inventor: Eric CHARLESTON, High Wycombe, Buckinghamshire (GB)

(21) Appl. No.: 15/112,253

(22) PCT Filed: Jan. 12, 2015
(86) PCT No.: PCT/GB2015/050048

§ 371 Date: Jul. 18, 2016

(30) Foreign Application Priority Data
Jan. 20, 2014 (GB) 1400914.6

(51) Int. Cl. B60N 2/50; B60N 2/64; B60N 2/40; B60N 2/44; B60N 2/48

(52) U.S. Cl. CPC B60N 2/503; B60N 2/449; B60N 2/48; B60N 2/40; B60N 2/64; B63B 2029/043

(57) ABSTRACT

The present invention relates to a seat (110) comprising a seating portion (112); a backrest (114) connected to the seating portion (112) and upstanding therefrom; restraining wings (116) configured to extend from opposing sides of the backrest (114) in a forward direction, and a protrusion (128) extending outwardly from an outer surface of each restraining wing (116). The restraining wings (116) are configured to flex in a direction towards one another.

The present invention relates to a seat, in particular a seat for a vehicle or vessel wherein an occupant may be subjected to high and frequent vibrations.

An example of such a vehicle or vessel is a small marine vessel.

In small marine vessels, such as a motorboat or a speedboat, a user and/or passenger is much closer to the waves. As a result, he/she is likely to feel the effects of the waves on the vessel.

In calm waters or travelling at low speeds, the effects of the wave on the vessel when translated to the user/passenger are at a tolerable or bearable level. However, in turbulent waters or travelling at high speeds, these effects can be unbearable.

In turbulent waters or travelling at high speeds there is also the risk of an occupant being dislodged from his/her seat, which can lead to an injury.

In addition, there is a risk of injuries due the high and frequent vibrations of the body, and by rapid and unexpected twisting and bending of the occupant's spine in turbulent waters or travelling at high speeds.

In some applications, seat belts and/or harnesses have been provided to reduce the risk of an occupant being dislodged from a seat in turbulent waters or travelling at high speeds. However, there is a reluctance by occupants of marine vessels to be fastened into their seats by the use of seat belts and/or harnesses due to the fear of being trapped in a sinking vessel.

Another example of a vehicle or vessel where an occupant may be subjected to high and frequent vibrations is an off-road vehicle.

Off-road vehicles, in particular automobiles, may comprise a seat-belt associated with the seat. The seat-belt may be in the form of a two-point or a three-point seat-belt. However, such seat-belts only protect the occupant against harmful movement that may result during a collision or a sudden stop. The occupant is still subjected to high and frequent vibrations and as a result, there is the risk of injuries due the high and frequent vibrations of the body and by rapid and unexpected twisting and bending of the occupant's spine when travelling at high speeds or on rough terrain.

It is an object of the invention to provide a seat for a vehicle or vessel which reduces the risk of injury to an occupant in turbulent waters, travelling at high speeds, or travelling on rough terrain.

According to a first aspect, there is provided a seat for a vessel comprising:
a seating portion;
a backrest connected to the seating portion and upstanding therefrom;
restraining wings configured to extend from opposing sides of the backrest in a forward direction; and
a protrusion extending outwardly from an outer surface of each restraining wing,
wherein the restraining wings are configured to flex in a direction towards one another.

Advantageously, each protrusion is arranged to rest in front of the arms of an occupant of the seat, and close to the crook of the bent arm of thin use. In this way, a seated occupant may hook his/her arms around the protrusions and allow his/her arms to rest in a relaxed manner with bent elbows, without any discomfort from the seat components.

In this way, the protrusions are adapted for engagement in use with the crook of the arm of a person seated in the seat.

Conveniently, the protrusions are of a shape and size that allows easy movement of a seat occupant's arms so that they can ‘unhook’ from said protrusions.

The present invention advantageously provides a seat for a vehicle or vessel which reduces the risk of injury to the spine of an occupant in turbulent waters, travelling at high speeds, or travelling on rough terrain.

The seat in accordance with the present invention mitigates injuries that may be caused by high and frequent vibrations of the body and by rapid and unexpected twisting and bending of the occupant's spine by maintaining the spine shape in an acceptable orientation during violent manoeuvres or sudden changes by the vehicle or vessel.

It has been shown that a close connection between the seat and the occupant, particularly in the back/spine region, is the best method of support and prevention of injury.

The seat in accordance with the invention may be utilized in vehicles or vessels which are provided with or without a seat-belt and/or harness.

When utilized in vehicles provided with a seat-belt and/or harness, the seat in accordance with the present invention will still mitigate or reduce the likelihood of injury due to vibrations even if the seat-belt and/or harness is not worn.

In exemplary embodiments, the seating portion is a saddle-type seating portion.

The saddle-type seating portion may be of a constant or varied width along the length thereof.

In a preferred exemplary embodiment, the saddle-type seating portion tapers with a front section of the seating portion having a smaller width than a rear section of the seating portion.

In another preferred exemplary embodiment, the saddle-type seating portion comprises a recess on opposing sides of the seating portion. In this way, an occupant can place his/her legs within the recesses in the seating portion which will help retain the occupant within the seat as sliding off the seat in the forward direction would be prevented.

In embodiments wherein the saddle-type seating portion comprises recesses, conveniently the recesses are proximate a front end of the seating portion.

Preferably, each protrusion is located proximate a front end of the restraining wing.

In exemplary embodiments, the backrest may comprise a deepening in a front surface of the backrest. Preferably, the deepening is substantially concave in shape, although the deepening may be of any suitable shape.

It will be appreciated that the term deepening describes a recessed, or inwardly curved, or inwardly extending, or hollowed out portion defined on the backrest.

In exemplary embodiments, the restraining wings are integrally formed with the backrest.

In alternative exemplary embodiments, the restraining wings are movable in height with respect to the seating portion.

The restraining wings are located relative to the seating portion such that an occupant may rest his/her arms against them in a comfortable manner.

For example, the restraining wings may be located at a distance of at least 20 cm above the seating portion.

Conveniently, the restraining wings may be located at a distance of at least 25 cm above the seating portion.

In exemplary embodiments, the seat further comprises a head restraint coupled to the backrest.

The head restraint may be integrally formed with the backrest. Alternatively, the head restraint may be separately formed from the backrest.

The invention will now be described by way of non-limiting example, with reference being made to the accompanying drawing, in which:

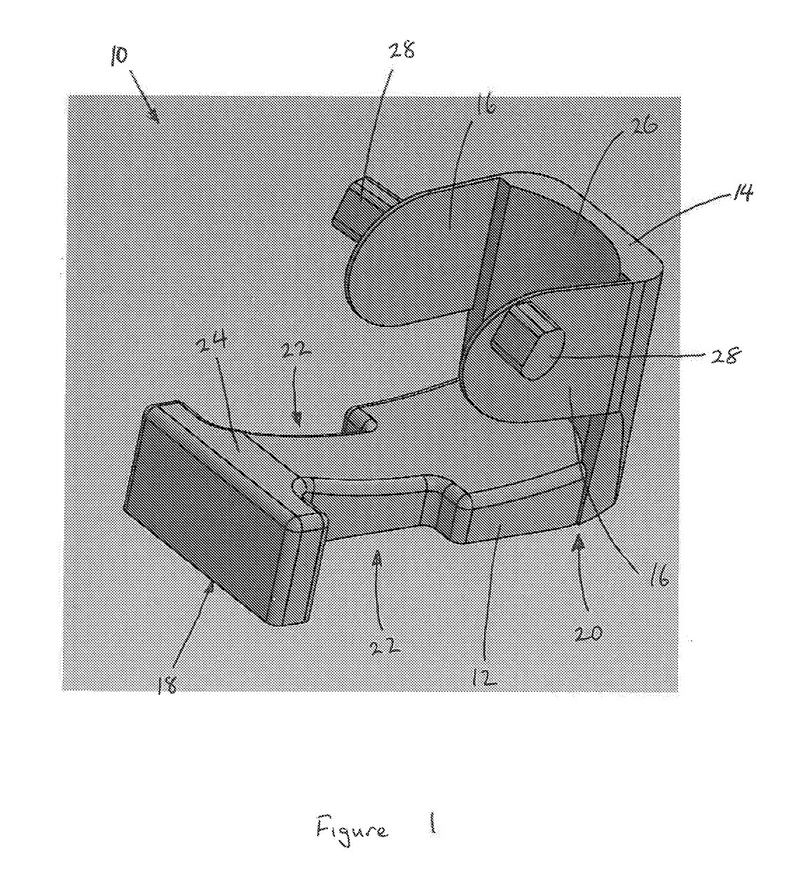

FIG. 1 is a schematic view of a first embodiment of a seat in accordance with the present invention; and

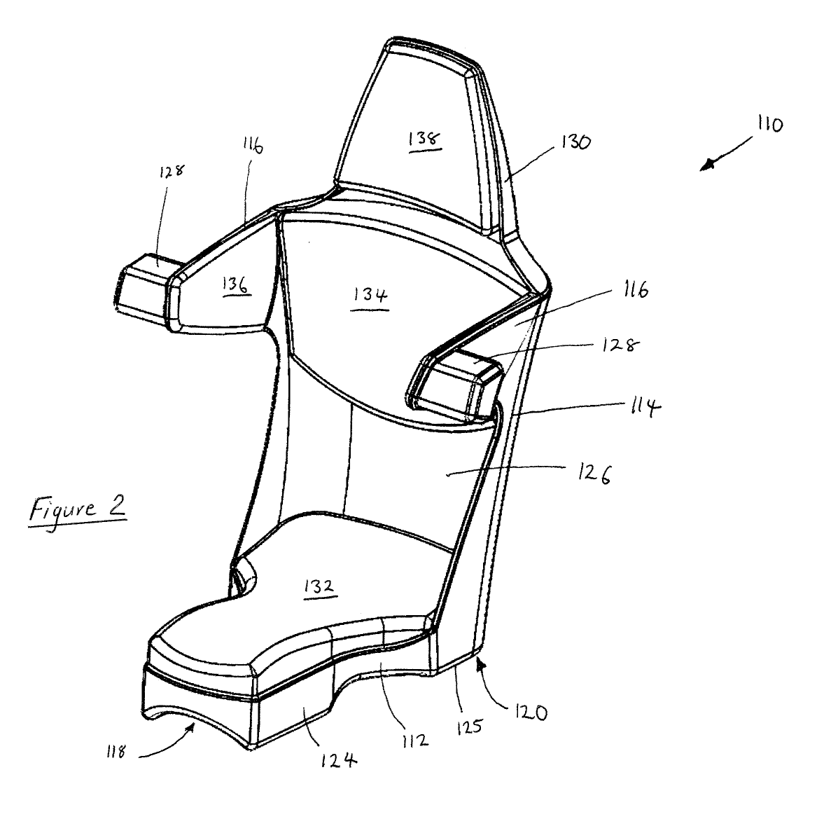

FIG. 2 is a schematic view of a second embodiment of a seat in accordance with the present invention.

The preceding discussion of the background to the invention is intended only to facilitate an understanding of the present invention. It should be appreciated that the discussion is not an acknowledgement or admission that any of the material referred to was part of the common general knowledge as at the priority date of the application.

Throughout the description and claims of this specification, the words “comprise” and “contain” and variations of those words, for example “comprising” and “comprises”, mean “including but not limited to”, and are not intended to (and do not) exclude other components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics, and compounds described in conjunction with a particular aspect, embodiment or example of the invention are to be understood to be applicable to any other aspect, embodiment or example described herein unless incompatible therewith.

Referring to FIG. 1, a first embodiment of a seat 10 for a vehicle or vessel in accordance with the invention is shown.

The seat 10 comprises a seating portion 12, a backrest 14 connected to the seating portion 12 and upstanding therefrom, restraining wings 16 configured to extend from the backrest 14 in a forward direction, and a protrusion 28 extending outwardly from an outer surface of each restraining wing 16.

The seating portion 12 comprises a first end 18 defining a front end of the seating portion 12 and a second end 20 defining a rear end of the seating portion 12. For clarity, the forward direction is a direction from the rear end 20 towards the front end 18 of the seating portion 12.

In the embodiment shown, the seating portion 12 is in the form of a saddle-type seating portion and comprises a recess 22 on opposing sides of the seating portion 12. The recesses 22 are proximate the front end 18 of the seating portion 12, and allow an occupant to place his/her legs within the recesses 22 so as to help retain the occupant within the seat 10. Sliding off the seat 10 in the forward direction would be prevented by the occupant's legs abutting against a front section 24 of the seating portion 12 forward of the recesses 22 in use.

The backrest 14 is connected to the second end 20 of the seating portion 12 and comprises a deepening 26 in a front surface of the backrest 14. In the embodiment shown, the deepening 26 is substantially concave in shape and is configured to support the back or spine region of an occupant.

The backrest 14 is configured to provide a high back seat, and is dimensioned so as to extend up to approximately the top of shoulder level of an average sized occupant in use.

The restraining wings 16 are configured to extend from opposing sides of the backrest 14 in a direction towards the front end 18 of the seating portion 12.

The restraining wings 16 are configured to flex in a direction towards one another, and, in the embodiment shown, the restraining wings 16 are integrally formed with the backrest 14.

It would be understood that the restraining wings 16 may instead be coupled to the backrest 14 by any suitable means rather than being integrally formed therewith.

The restraining wings 16 are located relative to the seating portion 12 such that an occupant may rest his/her arms against them in a comfortable manner. For example, the restraining wings 16 may be located at a distance of at least 20 cm above the seating portion 12, conveniently at a distance of at least 25 cm above the seating portion 12. It would be understood that the distance of the restraining wings 16 above the seating portion 12 may be less than 20 cm in order to allow an occupant to rest his/her arms against them in a comfortable manner.

In the embodiment shown, the restraining wings 16 are semi-circular and arch-shaped, although they may be of any suitable shape.

The restraining wings 16 are arranged and sized to fit around the sides of the occupant between his/her torso and arms, effectively just below the arm pits. The restraining wings 16 would be sufficiently flexible to accommodate varying sizes of occupants without discomfort.

The protrusions 28 are arranged to rest in front of the arms of the occupant and close to the crook of the bent arm in use. The arrangement is such that the seated occupant would hook his/her arms around the protrusions 28 and allow his/her arms to rest in a relaxed manner with bent elbows, without any discomfort from the seat components.

In this way, the protrusions are adapted for engagement in use with the crook of the arm of a person seated in the seat.

The protrusions 28 are also of a shape and size that allows easy movement of the arms so as to ‘unhook’ from the protrusions 28.

In the embodiment shown, each protrusion 28 is located proximate a front end and top edge of the respective restraining wing 16. It would be understood that the protrusions 28 may be located on the restraining wings 16 at any suitable location thereon.

While not shown in the depicted embodiment, the seat 10 may further comprise a head restraint coupled to the backrest.

The head restraint may be integrally formed with the backrest or alternatively may be separately formed from the backrest.

Referring to FIG. 2, a second embodiment of a seat 110 for a vehicle or vessel in accordance with the invention is shown.

The reference numerals for similar features of the second embodiment to those of the first embodiment have been increased by 100 for convenience. For example, the seating portion which was indicated by the reference numeral 12 in the first embodiment is now indicated by the reference numeral 112.

As in the first embodiment, the seat 110 in accordance with the second embodiment comprises a seating portion 112, a backrest 114 connected to the seating portion 114 and upstanding therefrom, restraining wings 116 configured to extend from the backrest 114 in a forward direction, and a protrusion 128 extending outwardly from an outer surface of each restraining wing 116.

The seating portion 112 comprises a first end 118 defining a front end of the seating portion 112 and a second end 120 defining a rear end of the seating portion 112.

As in the first embodiment, the seating portion 112 is in the form of a saddle-type seating portion. The saddle-type seating portion 112 comprises a front section 124 having a smaller width than a rear section 125 of the seating portion. As can be seen in FIG. 2, the seating portion 112 tapers in a forward direction.

The backrest 114 is connected to the second end 120 of the seating portion 112. The front surface of the backrest 114 may be concave or flat in shape.

As in the first embodiment, the backrest 114 is configured to provide a high back seat, and is dimensioned so as to extend up to approximately the top of shoulder level of an average sized occupant in use.

The restraining wings 116 are configured to extend from opposing sides of the backrest 114 in a direction towards the front end 118 of the seating portion 112.

The restraining wings 116 are configured to flex in a direction towards one another, and, in the embodiment shown, the restraining wings 116 are integrally formed with the backrest 114.

It would be understood that the restraining wings 116 may instead be coupled to the backrest 114 by any suitable means rather than being integrally formed therewith.

The restraining wings 116 are located relative to the seating portion 112 such that an occupant may rest his/her arms against them in a comfortable manner.

In the embodiment shown, the restraining wings 116 are in the shape of a convex quadrilateral, although they may be of any suitable shape.

The restraining wings 116 are arranged and sized to fit around the sides of the occupant between his/her torso and arms, effectively just below the arm pits. The restraining wings 116 would be sufficiently flexible to accommodate varying sizes of occupants without discomfort.

The protrusions 128 are arranged to rest in front of the arms of the occupant and close to the crook of the bent arm in use. The arrangement is such that the seated occupant would hook his/her arms around the protrusions 128 and allow his/her arms to rest in a relaxed manner with bent elbows, without any discomfort from the seat components.

The protrusions 128 are also of a shape and size that allows easy movement of the arms so as to ‘unhook’ from the protrusions 128.

In the embodiment shown, each protrusion 128 is located proximate a front end of the respective restraining wing 116. It would be understood that the protrusions 128 may be located on the restraining wings 116 at any suitable location thereon.

The seat 110 further comprise a head restraint 130 coupled to the backrest 114.

The head restraint 130 is shown integrally formed with the backrest 114, although it may be separately formed from the backrest 114.

The seat 110 may comprise one or more paddings positioned at certain location(s) of the seat.

In the embodiment shown, the seat 110 comprises a padding 132 coupled to the seating portion 112, a padding 134 coupled to the backrest 114, a padding 136 coupled to an inner surface of each restraining wing 116 (only one padding 136 is fully visible), and a padding 138 coupled to the head restraint 130. It would be understood that the paddings may be of any suitable shape and/or form and may be different to those depicted in FIG. 2. Backrest 114 may also comprise a deepening 126 in a front surface thereof. The deepening may be defined by the absence of a padding. Alternatively, the deepening may be defined by a padding having a thickness that is less than that of padding 134 such that padding 134 projects further forward from the front surface backrest 114.

The seat 10, 110 in accordance with the invention provides a seat for a vehicle or vessel which reduces the risk of injury to an occupant in turbulent waters, travelling at high speeds or travelling on rough terrain. The seat 10, 110 is designed to mitigate injuries that may be caused by high and frequent vibrations of the body and by rapid and unexpected twisting and bending of the occupant's spine by maintaining the spine shape in an acceptable orientation during violent manoeuvres or sudden changes by the vehicle or vessel.

During calm seas, on smooth terrain and/or at slow speeds the intent is that the occupant would sit naturally and comfortably within the wings 16, 116.

During more violent sea-movement, on rough terrain and/or at higher speeds the occupant would tense his/her arms, causing the restraining wings 16, 116 to flex inwards and hug the body close into the backrest 14, 114, thereby reducing the mobility of the back and spine. Due to the orientation of the arms, this tension would also occur naturally during an unexpected violent movement or sudden directional change, thereby automatically protecting the occupant.

The ease of release from the seat 10, 110 should also allay any fears the occupant may have of being trapped. It would also allow an incapacitated occupant to be removed with ease from his/her seat in the event of an emergency.

In an alternative embodiment of the invention, not shown, the restraining wings are configured to be movable in height with respect to the seating portion. In this way, the restraining wings can be adjusted so as to be positioned in a comfortable position for the occupant. The restraining wings will be movable from a locked position wherein the height of the restraining wing is not adjustable and an unlocked position wherein the height of the restraining wing may be adjusted.

While the embodiments of the invention have been described with the backrest comprising a deepening, it would be understood that the backrest may not comprise deepening.

In addition, while the embodiments of the invention have been described with the saddle-type seating portion tapering in shape or comprising recesses, it would be understood that the saddle-type seating portion may be of any suitable shape. For example, the saddle-type seating portion may be of a constant width.

In addition, while the embodiments of the invention have been described with the seating portion being a saddle-type seating portion, the seating portion may be of any suitable shape and/or configuration.

1. A seat comprising:
a seating portion;
a backrest connected to the seating portion and upstanding therefrom;
restraining wings configured to extend from opposing sides of the backrest in a forward direction; and
a protrusion extending outwardly from an outer surface of each restraining wing;
wherein the restraining wings are configured to flex in a direction towards one another.

2. A seat according to claim 1, wherein the seating portion comprises a saddle-type seating portion.

3. A seat according to claim 2, wherein the saddle-type seating portion comprises a front section having a smaller width than a rear section of the seating portion.

4. A seat according to claim 2, wherein the saddle-type seating portion comprises a recess on opposing sides of the seating portion.

5. A seat according to claim 4, wherein the recesses are proximate a front end of the seating portion.

6. A seat according to claim 1, wherein each protrusion is located proximate a front end of the restraining wing.

7. A seat according to claim 1, wherein each protrusion is arranged to rest in front of the arms of an occupant of the seat in use.

8. A seat according to claim 1, wherein each protrusion is adapted for engagement with the crook of the arm of a person seated in the seat in use.

9. A seat according to claim 1, wherein the backrest comprises a deepening in a front surface of the backrest.

10. A seat according to claim 9, wherein the deepening is substantially concave in shape.

11. A seat according to claim 1, wherein the restraining wings are integrally formed with the backrest.

12. A seat according to claim 1, wherein the restraining wings are movable in height with respect to the seating portion.

13. A seat according to claim 1, further comprising a head restraint coupled to the backrest.

14. A seat according to claim 13, wherein the head restraint is integrally formed with the backrest.

15. A seat according to claim 13, wherein the head restraint is separately formed from the backrest.
